(19) United States
(12) Patent Application Publication
(10) Pub. No.: US 2026/0258251 A1
(43) Pub. Date: Sep. 3, 2026

(54) METHOD AND SYSTEM FOR PRODUCING A DRY MIXTURE OF CONDUCTIVE CARBON BLACK AND ACTIVE MATERIAL

(71) Applicant: NEUMAN & ESSER PROCESS TECHNOLOGY GMBH, Übach-Palenberg (DE)

(72) Inventor: Marc GIERSEMEHL, Krefeld (DE)

(21) Appl. No.: 19/164,647

(22) PCT Filed: Mar. 13, 2024
(86) PCT No.: PCT/EP2024/056668

§ 371 Date: Sep. 12, 2025

(30) Foreign Application Priority Data
Mar. 20, 2023 (DE) 102023106937.3

(51) Int. Cl. C09C 1/56; H01M 4/583; H01M 4/62

(52) U.S. Cl. CPC C09C 1/56; H01M 4/583; H01M 4/625; C01P 2004/64; C01P 2006/10; C01P 2006/11; C01P 2006/12; C01P 2006/40

(57) ABSTRACT

The invention relates to a method for producing a dry mixture consisting of conductive carbon black (16) and an active material for the production of anode material for an electrochemical cell, in particular a battery cell, in which in a first step only the conductive carbon black (16) is adjusted by shearing to a bulk density of <0.05 g/cm³, preferably <0.03 g/cm³, and in a second, subsequent step, is mixed with the active material.

The invention relates to a method for producing a dry mixture consisting of conductive carbon black and an active material for the production of anode material for an electrochemical cell, in particular a battery or accumulator cell, such as, for example, a lithium-ion accumulator.

The functional components of a coating for anodes of lithium-ion accumulators include an electrochemically active material, namely the so-called active material, which is typically formed from graphite, additives to increase electrical conductivity, the so-called conductive additives, which are mainly formed from conductive carbon blacks, and the electrically/electrochemically inactive binder.

At the beginning of the production of anode material, a dry mixing process is often used in which the powdered components graphite and conductive carbon black are mixed. A typical dry mixing process is described in publication US 2016/0013473 A1. This is followed by a dispersion process in which the binder is dissolved and interacts with the graphite and conductive carbon black to form a suspension. Then the current collector foils are coated with the suspension, dried, and the resulting layer composite is compacted.

A somewhat different mixing process is described in DE 10 2017 213 403 A1, according to which a binder is initially processed with a first electrode component under high shear stress to form a mixture, whereby the binder is intended to fibrillate due to relative motion between the electrode component and the binder. Subsequently, a second electrode component is added to the mixture under lower shear stress.

The inventors have recognized that the attachment of the conductive carbon black particles to the particles of the active material positively affects the electrode conductivity of the finished anode material and have therefore set themselves the task of providing a dry mixing process that improves the result of the mixture of conductive carbon black particles and active material while also being efficient.

This object is solved by a method according to claim 1 and a system according to claim 12.

The method according to the invention for producing the dry mixture of conductive carbon black and an active material provides, in a first step, that the conductive carbon black is conditioned in isolation to a bulk density of <0.1 g/cm³, preferably <0.08 g/cm³, particularly preferably <0.05 g/cm³, and more preferably <0.03 g/cm³, and in a second, subsequent step, the conductive carbon black is mixed with the active material.

The invention is based on the insight that the state of the conductive carbon black at the moment of first contact with the active material during mixing has a significant impact on the distribution of the conductive carbon black particles along the surface of the active material particles. Conductive carbon black typically has a primary particle size of 10 to 50 nm, which particles initially form so-called aggregates of 100 to 300 nm due to van der Waals interactions, and then further agglomerates of micrometer-scale dimensions. In its delivered state, conductive carbon black therefore usually has a bulk density of about 0.1 g/cm³ or more due to aggregation and agglomeration caused by storage and transport. It is assumed that this property hinders a homogeneous distribution of conductive carbon black particles in the dry mixture.

Therefore, the method according to the invention provides that the conductive carbon black is pretreated in isolation in the first step of the method. In this context, “in isolation” means that the conductive carbon black is treated in the first step without the presence of particles of the active material or any other substance. Above all, the agglomerates are broken down in this first step. This process step is also referred to as “destructuring.” The inventors have found that destructuring leads to an increase in the volume of the conductive carbon black. A measure for the success of this first process step is therefore the bulk density of the conductive carbon black, where “bulk density” refers to that determined in accordance with DIN ISO 697/EN ISO 60. This is less than 0.1 g/cm³ as a result of the first process step, preferably less than 0.08 g/cm³, more preferably less than 0.05 g/cm³, and most preferably less than 0.03 g/cm³.

Preferably, the conductive carbon black is formed from primary particles having a median size (d50) of 10 to 50 nm.

Adjusting the bulk density is easily achieved by mechanical stress on the initial state conductive carbon black, preferably by subjecting the conductive carbon black to reproducible shear or impact stress. (Fine) impact mills are preferably used for this purpose, and more preferably blowers, in particular a radial blower. Preferably, the conductive carbon black is dosed into a suction line of the blower. This is preferably done gravimetrically.

Destructuring of the conductive carbon black is preferably carried out in the first step using shear stress at a shear rate of at least 10,000 s⁻¹, more preferably at least 12,000 s⁻¹, and most preferably at least 15,000 s⁻¹.

For this purpose, it has proven advantageous to feed the conductive carbon black to a blower in the first step, preferably a radial blower, which has a stator and rotating blower blades, wherein the shear stress with the mentioned shear rates is achieved in the gap between the rotating blower blades and the stator inside the housing.

The inventors have further recognized that a prior destructuring of the conductive carbon black allows the subsequent mixing to be carried out with significantly lower mechanical stress on the components than when the untreated conductive carbon black is added to the active material in the mixing vessel, and that this can further improve the electrical conductivity of the finished anode material compared to known mixing processes.

Only in the second, downstream step is the destructured conductive carbon black mixed with the active material. The active material preferably consists of graphite. Amorphous carbon or lithium titanate may also be considered, but play a subordinate practical role.

Graphite preferably has pretreated, rounded graphite particles to achieve the highest possible particle density in the anode coating, which cannot be achieved with angular (irregular) particles. “Rounded” here means that the edges and corners of the particles are broken, resulting in less interlocking in bulk. Compared to angular particles, they are relatively movable and can therefore be compacted into a denser sphere packing without destructive force. This ultimately leads to a higher energy density of the anode material. Especially preferred are initial graphite particles with a median size (d50) of 12 to 20 μm.

The degree of rounding can best be parameterized by the BET surface area and the tap density of the graphite particle material. Preferably, graphite is used as the base material that, before mixing with conductive carbon black, has a BET surface area according to DIN ISO 9277 of 6 m²/g to 12 m²/g and a tap density according to DIN ISO 787-11 of greater than 0.8 g/ml, preferably greater than 0.85 g/ml, more preferably greater than 0.9 g/ml, and even more preferably greater than 0.95 g/ml.

To achieve the desired properties, preferably 1 to 5 wt. % conductive carbon black and 95 to 99 wt. % graphite are mixed.

The goal in the second process step is to preserve the degree of rounding as much as possible. It has proven advantageous to operate the mixing process gently and, in particular, to carry it out in a second step that is independent from the destructuring of the conductive carbon black. It has surprisingly been found that such a mixing process, despite the gentle treatment of the mixture, does not result in any significant disadvantages in terms of the mixing result.

Preferably, the mixing of the conductive carbon black with the active material in the second step is carried out using a mixer at a shear rate of at least 1,000 s⁻¹ and preferably at least 2,000 s⁻¹. Furthermore, the shear rate during mixing is preferably at most 5,000 s⁻¹.

Also preferably, the mixing is carried out under these conditions for a mixing duration of at least 200 seconds, preferably at least 400 seconds.

Through mixing of the conductive carbon black with the graphite in the second step, a dry mixture with a tap density according to DIN EN ISO 787-11 of at least 0.8 g/cm³, preferably at least 0.85 g/cm³, is preferably produced, which is almost unchanged compared to the starting graphite material of 0.9 g/ml due to gentle mixing. Ideally, the tap density of the powder mixture is higher than that of the base graphite if the soot particles fill the voids between and in the unchanged rounded graphite particles, thereby increasing the mass but not the volume of the powder mixture.

Preferably, the mixing of conductive carbon black with graphite in the second step produces a dry mixture with a specific BET surface area according to DIN ISO 9277 of at most 7 m²/g, preferably at most 5.2 m²/g. This value is also almost unchanged from that of the pure base graphite and ideally even lower. A low specific BET surface area indicates an ideal powder form of the conductive carbon black, which shows optimal coating or wetting behavior and forms a uniform layer on the active material particles and ideally even fills their pores.

The properties of the dry mixture can be summarized in the following matrix:

| | | | |
|---|---|---|---|
| 1. | specific surface area low | 2. | specific surface area high |
| | tap density low | | tap density low |
| 3. | specific surface area low | 4. | specific surface area high |
| | tap density high | | tap density high |

The first case indicates excessive shear during mixing, which damages the active material and reduces the tap density despite good wetting by a near-ideally powdered carbon black.

In the second case, it is assumed that excessive shear during mixing on the one hand, and insufficiently destructured carbon black on the other hand, are the cause. As a result, the active material can no longer be optimally compacted, and at the same time, the carbon black does not optimally wet the active material either.

The third case is that achieved by the inventive dry mixing process. The carbon black is sufficiently destructured in the upstream first process step to coat the active material particles almost uniformly in the second process step, which in turn do not suffer any structural damage during mixing.

In the fourth case, it is assumed that although the mixing is gentle, the carbon black is not sufficiently destructured, which leads to an increased specific surface area due to the carbon black aggregates and agglomerates.

Preferably, after the first step, the destructured carbon black is subjected to a separation process in which the carbon black is separated from the carrier gas from the radial blower by means of a separator and then fed to the mixer. The destructured carbon black is preferably transported to the separator by the gas stream from the radial blower. From there, the carbon black simply falls into the mixer by gravity. The first process step can be carried out very efficiently due to a very short residence time of the carbon black in the blower. The carbon black particles are then transferred directly to the second process step for coating the active material without intermediate storage, so that the risk of re-agglomeration or re-aggregation is largely excluded.

The system according to the invention for producing a dry mixture consisting of conductive carbon black and an active material for the production of anode material for an electrochemical cell, in particular a battery cell, comprises a destructuring device which is configured to subject the carbon black in isolation to a shear or pressure load sufficient to adjust the bulk density of the carbon black to <0.1 g/cm³, preferably <0.08 g/cm³, particularly preferably <0.05 g/cm³, more preferably <0.03 g/cm³, and a mixer downstream of the destructuring device, which is configured to mix the destructured carbon black with the active material.

Preferably, the destructuring device is formed by a blower, more preferably a radial blower, which has a stator and rotating blower blades and is configured to generate a shear rate of at least 10,000 s⁻¹, preferably at least 12,000 s⁻¹, particularly preferably at least 15,000 s⁻¹ in a gap between the rotating blower blades and the stator.

The mixer is preferably configured to generate a shear rate of at least 1,000 s⁻¹ and preferably at least 2,000 s⁻¹ and further preferably at most 5,000 s⁻¹. To this end, it preferably comprises, similarly to the blower, a housing with a stator and rotating mixing tools therein, whereby the shear stress with the specified shear rates is generated in the gap between the rotating mixing tools and the stator inside the housing.

The blower is connected to the mixer via a fluid line. In the fluid stream within this fluid line between the radial blower and the mixer, a separator is preferably arranged, which is configured to separate the carbon black—i.e., carbon black particles and/or aggregates and/or agglomerates—from the stream of a carrier gas from the radial blower. The separator is preferably a filter, a cyclone separator or an electrostatic filter, or a combination thereof.

Accordingly, the radial blower is preferably also configured to generate a sufficient gas stream with which the carbon black can be transported through the fluid line and the separator to the mixer. Thus, the blower has, in addition to the function of destructuring the carbon black, the function of providing a sufficient volume flow for transporting the carbon black to the subsequent processing step.

Further advantages and features of the invention are described below with reference to the figures. These show:

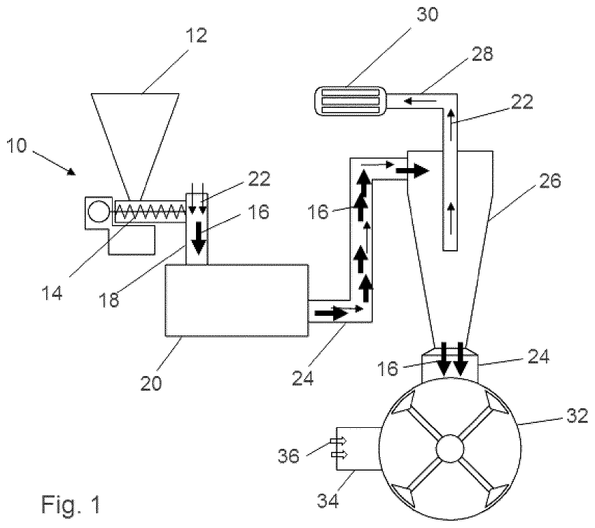

FIG. 1: an embodiment of the system according to the invention.

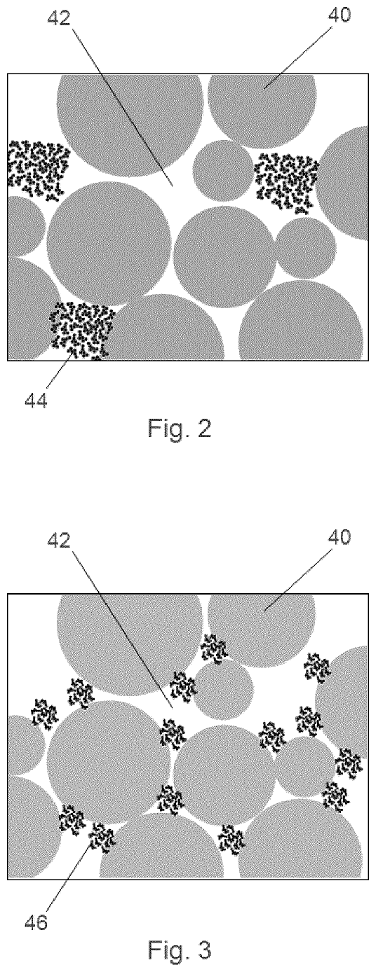

FIG. 2: a schematic representation of the dry mixture after simple mixing.

FIG. 3: a schematic representation of the dry mixture after intensive mixing.

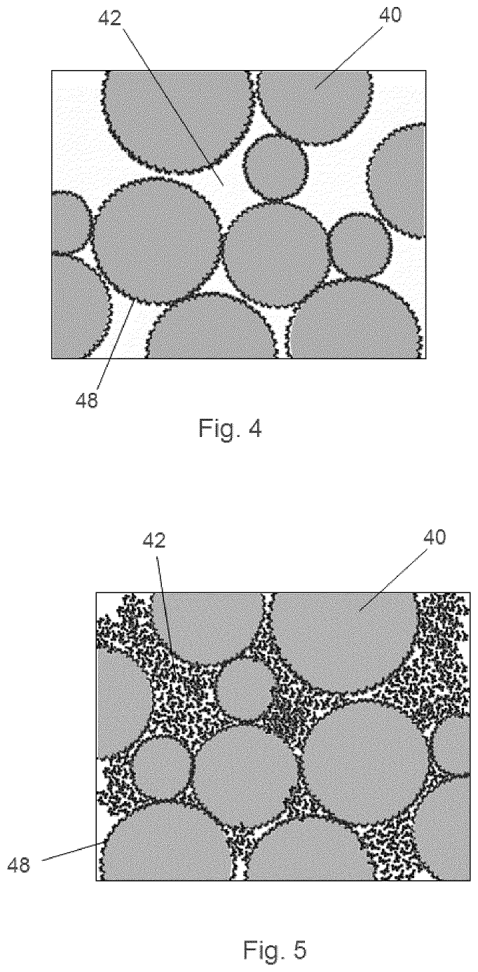

FIG. 4: a schematic representation of the dry mixture in which ideally powdery conductive carbon black is homogeneously attached to the particles of the active material.

FIG. 5: a schematic representation of the dry mixture of ideally powdery conductive carbon black with active material, in which the voids between the particles of the active material are also filled with conductive carbon black.

The system according to the invention for producing a dry mixture, as shown in FIG. 1, comprises at its inlet side a metering device (10) with a container (12) and a conveying device (14) for the conductive carbon black (16). The conveying device (14) is shown here as a screw conveyor, but is not fundamentally limited to such a conveying system. The metering can optionally be carried out by the metering device either volumetrically or gravimetrically. In the latter case, a scale is also provided, for example to weigh the container (12). Based on the determined mass reduction, the conveying speed of the conveying device (14) can then be regulated.

The conductive carbon black (16) is dosed in this way into a suction channel (18) of a radial blower (20), through which at the same time a carrier gas (22), preferably air, is drawn in. In the radial blower (20), the conductive carbon black (16) is exposed in the first process step to a shear rate of at least 10,000 s⁻¹, preferably at least 12,000 s⁻¹, and particularly preferably at least 15,000 s⁻¹. This is selected by setting and/or regulating a certain blower speed for a given blower geometry. In this way, it is possible to adjust the bulk density of the conductive carbon black to <0.1 g/cm³, preferably <0.08 g/cm³, particularly preferably <0.05 g/cm³, and more preferably <0.03 g/cm³.

At the outlet side, the radial blower (20) is connected to a fluid line (24), through which the now destructured conductive carbon black (16) is pneumatically transported in the stream of the carrier gas (22) to a connected separator (26). In the example shown, this is a cyclone separator, although the system according to the invention is not limited to the use of a cyclone separator. In the separator (26), the destructured conductive carbon black (16) is separated from the carrier gas (22). The carrier gas (22) passes through an exhaust line (28) to a filter (30), where it is purified of any remaining conductive carbon black and discharged into the environment.

Through the fluid line (24), the conductive carbon black (16) is fed from the separator (26) to a mixer (32), to which rounded active material (36) is also fed via another fluid line (34) or optionally the same fluid line (24) (not shown here in this way). In the mixer (32), the conductive carbon black (16) is mixed in the second process step with the active material (36) at a shear rate of at least 1,000 s⁻¹, preferably at least 2,000 s⁻¹, over a duration of at least 200 seconds, preferably at least 400 seconds. Due to the mechanical stress, the materials are mixed, with the conductive carbon black particles partially adhering to the active material particles, thereby forming a coating that increases the contact surface of the graphite particles.

Further portions of the conductive carbon black, in particular aggregates not completely broken down in the first process step, fill the voids between the active material particles and thus further increase the contact surface between adjacent active material particles, which explains the overall improved particle conductivity of the dry mixture.

In FIGS. 2 to 5, four different states of the dry mixture are illustrated schematically. In each case, the active material particles (40) are idealized as circular cross-sections of spheres. Voids (42) are enclosed between adjacent active material particles. The task of the conductive carbon black is to improve the contacting of the active material particles with each other.

FIG. 2 shows the idealized case in which the conductive carbon black is present in the form of agglomerates (44) enclosed in some of the voids (42) between the active material particles (40). Where carbon black is enclosed, the agglomerates form electrical bridges and increase the number of contacts between adjacent active material particles. The carbon black agglomerates have approximately a diameter in the same order of magnitude as the active material particles. As a result, not all voids (42) contain carbon black, and the increase in contact points does not occur between all neighboring active material particles, which suggests only a minor improvement in powder conductivity.

FIG. 3 also presents an idealized depiction of a case in which the conductive carbon black is in the form of smaller aggregates (46). These aggregates (46) are about one order of magnitude smaller than the active material particles and thus fit in most of the voids (42) between the active material particles (40), where they form electrical bridges similarly to the agglomerates (44). This further increases the number of contacts between adjacent active material particles, but does not yet achieve a significant improvement in powder conductivity.

FIG. 4 shows an idealized depiction with conductive carbon black in the form of pure primary particles (48), which are several orders of magnitude smaller than the active material particles (40). The conductive carbon black particles (48) adhere uniformly to the surface of the active material particles (40). While this does not form additional electrical bridges, it enlarges the individual contact points, which contributes to improved powder conductivity.

FIG. 5 finally illustrates the state in which the conductive carbon black not only adheres uniformly to the surface of the active material particles but also fills the voids between them. The carbon black particles (48) likewise attach evenly to the surface of the active material particles (40), increasing the contact surface area. In the voids between the active material particles, they form additional electrical bridges.

### LIST OF REFERENCE SIGNS

10 System
12 Container
14 Conveying device
16 Conductive carbon black
18 Suction duct
20 Radial blower
22 Carrier gas
24 Fluid line
26 Separator
28 Exhaust line
30 Filter
32 Mixer
34 Second duct
36 Active material
40 Active material particles
42 Void
44 Conductive carbon black agglomerate
46 Conductive carbon black aggregate
48 Conductive carbon black particles

1. A method for producing a dry mixture consisting of conductive carbon black and an active material for the production of anode material for an electrochemical cell, in particular a battery cell, wherein in a first step the conductive carbon black is conditioned in isolation to a bulk density of <0.1 g/cm³, preferably <0.08 g/cm³, particularly preferably <0.05 g/cm³, more preferably <0.03 g/cm³, and in a second, subsequent step, the conductive carbon black is dry-mixed with the active material.

2. The method according to claim 1, wherein the conductive carbon black is formed from primary particles with a median size (d50) of 10 to 50 nm.

3. The method according to claim 1, wherein the active material consists of graphite.

4. The method according to claim 1, wherein 1 to 5 wt. % conductive carbon black and 95 to 99 wt. % graphite are mixed.

5. The method according to claim 1, wherein in the first step the bulk density of the conductive carbon black is adjusted by means of a shear rate in the range of 10,000 s⁻¹, preferably at least 12,000 s⁻¹, and particularly preferably at least 15,000 s⁻¹.

6. The method according to claim 5, wherein in the first step the conductive carbon black is fed to a blower, preferably a radial blower, with a stator and rotating blower blades, wherein the shear rate is generated in a gap between the rotating blower blades and the stator.

7. The method according to claim 1, wherein the mixing of the conductive carbon black with the active material in the second step is carried out by means of a mixer at a shear rate of at least 1,000 s⁻¹ and preferably at least 2,000 s⁻¹.

8. The method according to claim 7, wherein, after the first step, the conductive carbon black is subjected to a separation process in which the conductive carbon black is separated from a carrier gas from the blower and subsequently fed to the mixer.

9. The method according to claim 1, wherein, by mixing the conductive carbon black with the graphite in the second step, a mixture with a tap density according to DIN EN ISO 787-11 of at least 0.8 g/cm³, preferably at least 0.85 g/cm³, is produced.

10. The method according to claim 1, wherein, by mixing the conductive carbon black with the graphite in the second step, a mixture with a specific BET surface area of at most 7 m²/g, preferably at most 5.2 m²/g, is produced.

11. The method according to claim 1, wherein, by mixing the conductive carbon black with the graphite in the second step, a mixture with a powder conductivity of at least 3.5×10⁻² S/cm, preferably at least 3.7×10⁻² S/cm, is produced.

12. A system for producing a dry mixture consisting of conductive carbon black and an active material for the production of anode material for an electrochemical cell, in particular a battery cell, comprising:
a destructuring device designed to subject the conductive carbon black in isolation to a shear or pressure load sufficient to adjust the bulk density of the conductive carbon black to <0.1 g/cm³, preferably <0.08 g/cm³, particularly preferably <0.05 g/cm³, more preferably <0.03 g/cm³; and
a mixer downstream of the destructuring device, which is configured to mix the conductive carbon black with the active material.

13. The system according to claim 12, wherein the destructuring device is a blower, preferably a radial blower, with a stator and rotating blower blades, which is configured to generate a shear rate of at least 10,000 s⁻¹, preferably at least 12,000 s⁻¹, and particularly preferably at least 15,000 s⁻¹ in a gap between the rotating blower blades and the stator.

14. The system according to claim 12, wherein the mixer is configured to generate a shear rate of at least 1,000 s⁻¹ and preferably at least 2,000 s⁻¹.

15. The system according to claim 14, further comprising a separator, preferably a filter, a cyclone separator, or a total separator, integrated into the fluid stream between the blower and the mixer and configured to separate the conductive carbon black from a carrier gas from the blower.
